(19) United States
(12) Patent Application Publication
(10) Pub. No.: US 2007/0175347 A1
(43) Pub. Date: Aug. 2, 2007

(54) Printing spacers on LCD substrates

(75) Inventors: Bong-Sung Seo, Gyeonggi-do (KR); So-Youn Park, Gyeonggi-do (KR); Jeong-Uk Heo, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd., Suwon-si (KR)

(21) Appl. No.: 11/543,538

(22) Filed: Oct. 4, 2006

(30) Foreign Application Priority Data
Jan. 27, 2006 (KR) 2006-8647

(51) Int. Cl. B41F 31/00

(52) U.S. Cl. 101/350.6

(57) ABSTRACT

A spacer ink printing apparatus for printing spacers on an LCD substrate includes a main body, a pressing roller and a spacer ink removing portion. The apparatus may further include a spacer ink guiding portion and/or a spacer ink spreading portion. The pressing roller is combined with the main body and rotates so as to press a spacer ink sprayed onto a printing plate into each of a plurality of receiving recesses of the printing plate. The spacer ink removing portion is combined with the main body and serves to remove any excess spacer ink from the printing plate, thereby reducing wasted spacer ink and decreasing the manufacturing cost of LCDs produced with the apparatus.

### RELATED APPLICATIONS

This application claims priority of Korean Patent Application No. 2006-8647, filed Jan. 27, 2006, the entire contents of which are incorporated herein by reference.

### BACKGROUND

The present invention relates to an apparatus for printing spacers on a substrate of a liquid crystal display (LCD) and a method of manufacturing an LCD panel using the apparatus that reduces the manufacturing cost of the panel.

A typical LCD includes a liquid crystal display panel that displays an image using the light transmittance of a layer of liquid crystal material contained in the panel and a backlight assembly disposed below the panel for providing the panel with light.

The LCD panel includes a first substrate provided with a plurality of switching elements, such as thin-film transistors (TFTs), a second substrate that faces the first substrate and is provided with a plurality of color filters, a layer of a liquid crystal material interposed between the first and second substrates, a seal line formed between the first and second substrates around their respective peripheries that seals the liquid crystal layer between the two substrates, and a plurality of spacers disposed between the two substrates that maintains a selected spacing, or “cell gap,” between the two substrates.

Various methods can be used for forming the liquid crystal layer between the two substrates, including methods in which the liquid crystal material is injected or dropped onto the panel in the form of droplets. Currently, the droplet method is more widely used, in which a seal line and a plurality of spacers are formed on the second substrate. A measured quantity of the liquid crystal material is then dropped onto the first substrate in the form of droplets, and the first substrate is then sealingly combined with the second substrate in the presence of a vacuum.

The spacers are typically printed on the second substrate through a printing process using a spacer-filled liquid “spacer ink” and a printing roller. In particular, the spacer ink is sprayed onto a printing plate containing a plurality of receiving recesses, and the spacers contained in the ink are then forced into the recesses of the plate with a “doctor blade.” The printing roller is rolled over the printing plate so as to adhere the spacers in the recesses to an outer surface of the printing roller, and is then rolled over the second substrate so as to print the spacers onto the substrate in positions that correspond to the positions of the recesses in the printing plate. When the spacer ink is forced into the receiving recesses of the printing plate with the doctor blade, a substantial amount of the excess spacer ink that is not forced into the recesses is wiped off of the surface of the plate and thereby lost, or wasted. This waste of spacer ink increases the cost of the spacer ink application process, and thus, increases the manufacturing cost of LCDs using the process.

### BRIEF SUMMARY

In accordance with the various exemplary embodiments thereof described herein, the present invention provides a spacer ink printing apparatus and a method of manufacturing a display panel using the apparatus that substantially reduce the waste of spacer ink used in the manufacture of LCD panels, and hence, the manufacturing cost of the panels.

In accordance with one exemplary embodiment thereof, a spacer ink printing apparatus comprises a main body, a pressing roller and a spacer ink removing portion. The spacer ink printing apparatus may further include a spacer ink guiding portion and/or a spacer ink spreading portion.

The pressing roller is combined with the main body and rotates so as to press a spacer ink previously sprayed onto an upper surface of a printing plate into a plurality of ink-receiving recesses in the upper surface of the plate. The spacer ink removing portion is combined with the main body and operates to remove any excess spacer ink from the upper surface of the printing plate after the recesses in the plate have been loaded with ink. The spacer ink guiding portion is disposed adjacent to an outer surface of the pressing roller and operates to guide the spacer ink relative to the pressing roller. The spacer ink spreading portion is combined with the main body and functions to level, or reduce the height of, the spacer ink on the upper surface of the printing plate before it is encountered by the pressing roller.

In another aspect of the present invention, an exemplary embodiment of a method of manufacturing a display panel with the novel apparatus is provided. In this exemplary method, a spacer ink sprayed onto a printing plate is pressed into each of a plurality of receiving recesses of the printing plate by using a spacer ink printing apparatus. A printing roller is rotated over the printing plate so to adhere the spacer ink onto an outer surface of the printing roller. The printing roller is then rotated over a first LCD substrate so as to print the spacer ink adhered to the outer surface of the printing roller onto the first substrate at selected positions thereon. A seal line is formed around a periphery of the first substrate. Droplets of a liquid crystal material are dropped onto a second substrate. The first substrate is then combined with the second substrate such that a space is defined between the two substrates and a layer of the liquid crystal material is sealed within the space.

The spacer ink printing apparatus includes a main body, a pressing roller, and a spacer ink removing portion. The pressing roller is combined with the main body and rotates to press spacer ink that was previously sprayed onto the printing plate such that the spacer ink is uniformly disposed in each of the receiving recesses thereof. The spacer ink removing portion is combined with the main body and operates to remove excess spacer ink from the printing plate. In operation, the spacer ink printing apparatus levels, or reduces the height of, the spacer ink sprayed onto the printing plate before it is encountered by the pressing roller. The apparatus also guides the spacer ink relative to the pressing roller and removes excess spacer ink from the printing plate, thereby enabling the ink to be recycled for reuse. Accordingly, the amount of spacer ink that is wasted during the printing process is substantially reduced and the reuse ratio of the spacer ink is substantially increased.

A better understanding of the above and many other features and advantages of the spacer printing methods and apparatus of the present invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a schematic partial cross-sectional side elevation view of an exemplary embodiment of a spacer ink printing apparatus in accordance with the present invention;

FIG. 2 is a schematic partial cross-sectional side elevation view of another exemplary embodiment of a spacer ink printing apparatus in accordance with the present invention; and,

FIGS. 3 to 11 are schematic partial cross-sectional views sequentially illustrating an exemplary embodiment of a method for manufacturing an LCD panel in accordance with the present invention.

### DETAILED DESCRIPTION

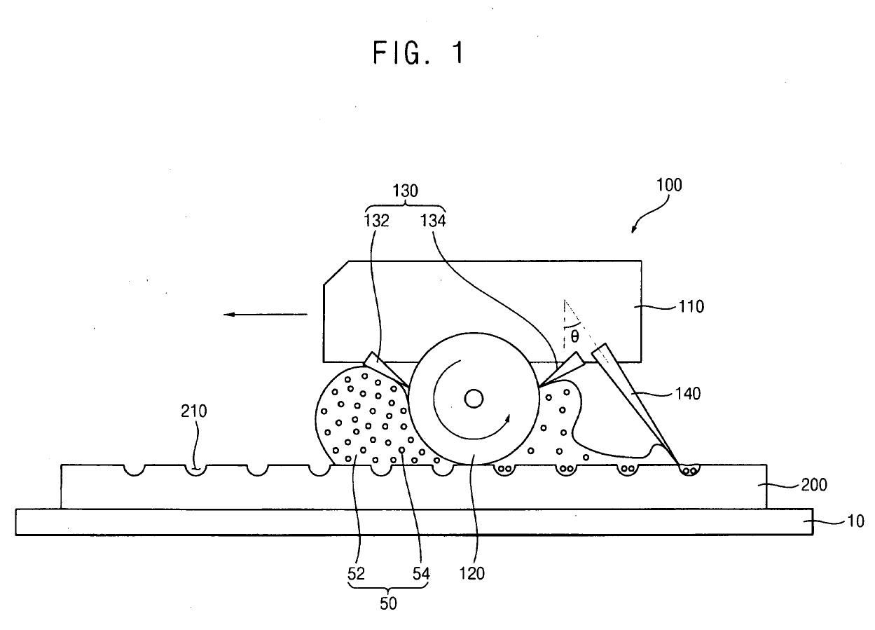

FIG. 1 is a schematic partial cross-sectional side elevation view of a first exemplary embodiment of an LCD substrate spacer ink printing apparatus 100 in accordance with the present invention. As shown in the figure, the exemplary first embodiment of the printing apparatus 100 includes a main body 110, a pressing roller 120, a spacer ink guiding portion 130 and a spacer ink removing portion 140. During operation, the apparatus 100 moves over a printing plate 200 to force a spacer ink 50 mixture that was previously sprayed onto the printing plate 200 uniformly into each of a plurality of receiving recesses 210 of the printing plate 200. The spacer ink 50 mixture includes liquid ink 52 having a controlled viscosity and a plurality of rigid, spherical spacers 54 dispersed randomly within the liquid ink 52.

The pressing roller 120, the spacer ink guiding portion 130 and the spacer ink removing portion 140 are combined in the main body 110 of the apparatus so as to move simultaneously with each other over the printing plate 200 in the direction of the arrow of translation shown in FIG. 1, and the pressing roller 120 is arranged so as to rotate simultaneously against the printing plate in the direction of the arrow of rotation of FIG. 1 and thereby press the spacer ink 50 into the recesses 210 of the plate. In particular, the pressing roller 120 is arranged at a lower portion of the main body 110 to translate in the direction indicated by the arrow in FIG. 1 in a rolling engagement with the printing plate 200 mounted on a stage 10 disposed below the apparatus. The moving pressing roller 120 presses the spacer ink 50 previously sprayed onto the printing plate 200 so as to press the spacer ink 50 into each of the receiving recesses 210 of the printing plate 200.

As shown in FIG. 1, the spacer ink guiding portion 130 is also combined with a lower portion of the main body 110 and is disposed adjacent to an exterior rolling surface of the pressing roller 120. The spacer ink guiding portion 130 operates to guide the spacer ink 50 disposed on the printing plate 200 uniformly onto the exterior surface of the of the printing roller 120. The spacer ink guiding portion 130 includes a first spacer ink guiding portion 132 and a second spacer ink guiding portion 134.

The first spacer ink guiding portion 132 is disposed adjacent to a first side of the pressing roller 120 that is disposed in the direction in which the printing roller is translated, as indicated by the arrow in FIG. 1, and includes a sharp end portion that is spaced apart from the surface of the pressing roller 120 by a selected distance. The first spacer ink guiding portion 132 functions to guide the spacer ink 50 uniformly onto the surface of the pressing roller 120. Specifically, the first spacer ink guiding portion 132 guides the spacer ink 50 uniformly onto the surface of the pressing roller 120 such that the rotating pressing roller 120 in turn forces the spacer ink 50 uniformly into the recesses 210 of the printing plate 200.

The second spacer ink guiding portion 134 is disposed adjacent to a second side of the pressing roller 120 opposite to the first side of the pressing roller 120, i.e., opposite to the direction in which the printing roller 120 translates, and includes a sharp end portion that is spaced apart from the surface of the pressing roller 120 by a selected distance. The second spacer ink guiding portion 134 functions to separate the spacer ink 50 adhering to the pressing roller 120 from the roller. Specifically, some of the spacer ink 50 that is pressed by the pressing roller 120 adheres to its external surface and rotates along with it. The second spacer ink guiding portion 134 acts to separate the spacer ink 50 adhering to the pressing roller 120 from it.

As discussed above, the first and second spacer ink guiding portions 132 and 134 guide the spacer ink 50 relative to the pressing roller 120 so that the pressing roller 120 presses the spacer ink 50 uniformly into the recesses 210 of the printing plate 200. Thus, if the excess ink, i.e., the ink that was initially sprayed onto the printing plate but which was not pressed into the recesses, is recovered and reused, it is possible to effect a substantial reduction in the amount of spacer ink 50 that is wasted in the printing process.

To this end, the spacer ink removing portion 140 is combined with the main body 110 and operates to removes the excess spacer ink 50 from the printing plate 200 for its ultimate reuse. Specifically, the spacer ink removing portion 140 is spaced apart from the pressing roller 120 by a selected distance in a direction opposite to the moving direction of the pressing roller 120. In the particular exemplary embodiment of FIG. 1, the spacer ink removing portion 140 is disposed adjacent to the second spacer ink guiding portion 134, and is inclined at an angle θ with respect to a vertical line that is substantially perpendicular to an upper surface of the printing plate 200, so that the pressing roller 120 is disposed farther from a first end portion of the spacer ink removing portion 140 than from an opposite second end portion of the spacer ink removing portion 140 that is combined with the main body 110. The angle of inclination θ may be between about 50 degrees to about 80 degrees.

In operation, the first end portion of the spacer ink removing portion 140 makes contact with the upper surface of the printing plate 200 when the pressing roller 120 simultaneously rotates and translates in the respective directions of the two arrows of FIG. 1. The first end portion of the spacer ink removing portion 140 wipes the excess spacer ink 50 remaining on the printing plate 200 after being pressed by the pressing roller 120 so as to remove it from the printing plate 200, such that the only ink remaining is that which is disposed in the receiving recesses 210 of the printing plate 200. The excess spacer ink 50 removed from the printing plate 200 by the spacer ink removing portion 140 can be reused, thereby reducing waste of the spacer ink 50.

Thus, in the exemplary embodiment illustrated in FIG. 1, the first spacer ink guiding portion 132 guides the spacer ink 50 uniformly onto the pressing roller 120, and the second spacer ink guiding portion 134 separates the spacer ink 50 from the pressing roller 120. The spacer ink removing portion 140 then removes the excess spacer ink 50 from the printing plate 200 for reuse, thereby preventing waste of the spacer ink 50.

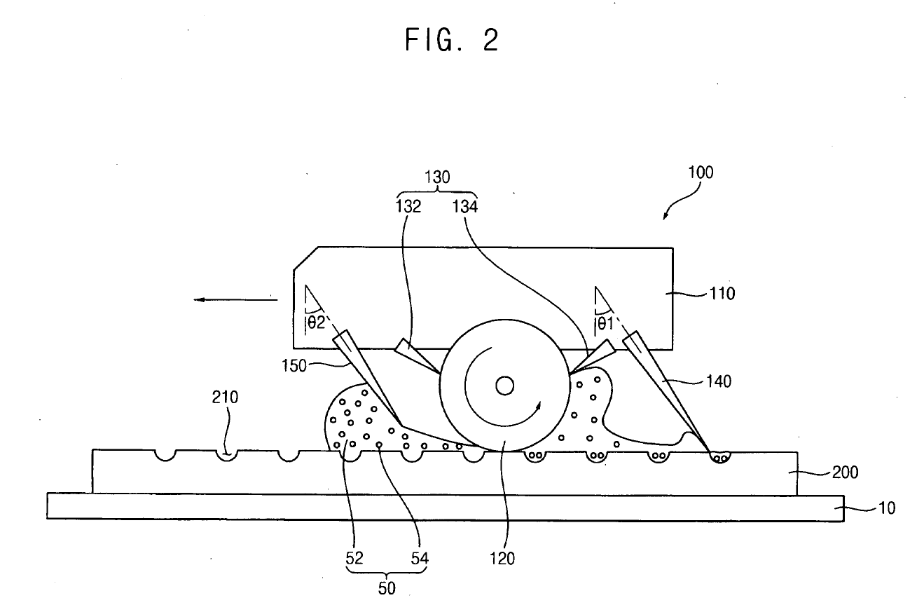

FIG. 2 is a schematic partial cross-sectional side elevation view of another exemplary embodiment of a spacer ink printing apparatus 100 in accordance with the present invention. As in the first embodiment described above, in the second embodiment of FIG. 2, the spacer ink printing apparatus 100 includes a main body 110, a pressing roller 120, a spacer ink guiding portion 130, a spacer ink removing portion 140, and differing from the first embodiment, a spacer ink spreading portion 150. Also, as in the first embodiment above, these portions are combined in the main body 110 of the apparatus to translate together over the upper surface of a printing plate 200 disposed on a stage 10 in the direction of the arrow of translation of FIG. 2, while the pressing roller 120 simultaneously rotates in the direction of the arrow of rotation therein, to press a quantity of spacer ink 50 previously sprayed onto the upper surface of the printing plate 200 into the ink-receiving recesses 210 therein.

The spacer ink guiding portion 130 is disposed adjacent to the pressing roller 120 and functions to guide the spacer ink 50 with respect to the roller. As in the first embodiment above, the spacer ink guiding portion 130 includes a first spacer ink guiding portion 132 and a second spacer ink guiding portion 134 disposed similarly to those of the first embodiment. The first spacer ink guiding portion 132 guides the spacer ink 50 uniformly onto the pressing roller 120, and the second spacer ink guiding portion 134 separates the spacer ink 50 adhering to the rotating pressing roller 120 from the surface of the roller.

As in the first embodiment above, the spacer ink removing portion 140 is disposed in combination with the main body 110 to remove excess spacer ink 50 from the printing plate 200 in a manner similar to that of the first embodiment described above. In the second embodiment of FIG. 2, the spacer ink removing portion 140 is inclined at a first angle θ1, which may be from about 50 degrees to about 80 degrees with respect to a line substantially perpendicular to an upper surface of the printing plate 200.

The spacer ink spreading portion 150 is combined with the main body 110 and functions to level, or reduce the height of, the volume of spacer ink 50 on the upper surface of the printing plate that is being encountered by the pressing roller 120 during its movement over the plate. Specifically, the spacer ink spreading portion 150 is spaced ahead of the pressing roller 120 by a selected distance in the direction in which the pressing roller 120 is translated, and is disposed below the main body 110, as shown in FIG. 2.

The spacer ink spreading portion 150 is inclined at a second angle θ2 with respect to a line that is substantially perpendicular to an upper surface of the printing plate 200 so that the pressing roller 120 is disposed closer to a first end portion of the spacer ink spreading portion 150 than to an opposite second end portion thereof that is combined with the main body 110. The second angle of inclination θ2 of the ink spreading portion 150 may be smaller than the first angle of inclination θ1 of the spacer ink removing portion 140. For example, the second angle θ2 may be from about 20 degrees to about 50 degrees. The first end portion of the spacer ink spreading portion 150 is spaced apart from the upper surface of the printing plate 200 by a selected distance. The first end portion of the spacer-spreading portion 150 functions to level, or reduce the height of, the spacer ink 50 that is encountered by the pressing roller 120 as it moves across the upper surface of the printing plate 200.

In the exemplary embodiment of FIG. 2, the spacer ink spreading portion 150 reduces the height of the spacer ink 50 provided to the pressing roller 120, thereby enabling the pressing roller 120 to press the spacer ink 50 into the ink-receiving recesses 210 of the printing plate 200 in a more uniform manner. In particular, when the spacer ink spreading portion 150 is omitted, an excessive amount of the spacer ink 50 can be encountered by the pressing roller 120, resulting in a reduction in the pressing efficiency of the pressing roller 120 and a decrease in the reuse ratio of the spacer ink 50. Thus, in the second embodiment of FIG. 2, the provision of the spacer ink spreading portion 150 functions to reduce the height of the volume of spacer ink 50 on the printing plate 200 that is encountered by the pressing roller 120 so as to provide the pressing roller 120 with a proper amount of the spacer ink 50. This increases both the pressing efficiency of the pressing roller 120 and the reuse ratio of the spacer ink 50.

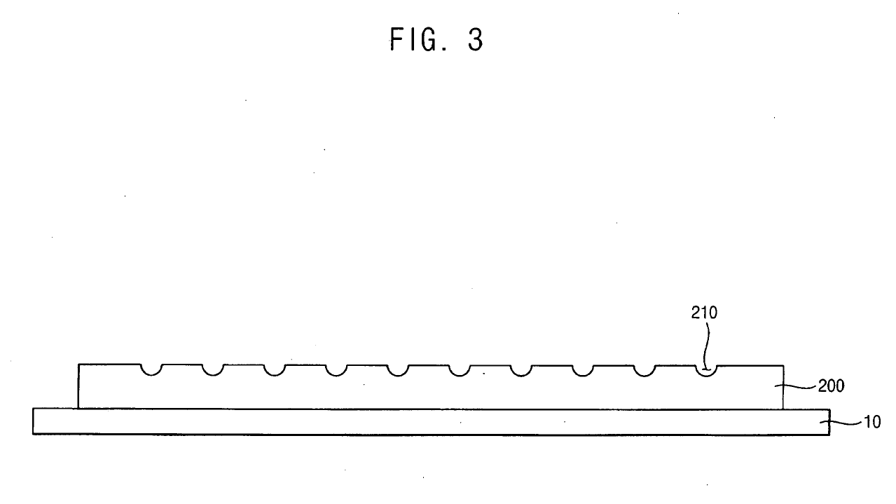

FIGS. 3 to 11 are schematic partial cross-sectional views sequentially illustrating an exemplary embodiment of a method for manufacturing an LCD panel in accordance with and using the novel apparatus of the present invention.

FIG. 3 illustrates a printing plate 200 having an upper surface containing a plurality of spacer ink receiving recesses 210. The printing plate 200 is disposed on a stage 10. The receiving recesses 210 are spaced apart from each other on the printing plate by selected distances, or at respective “pitches,” in the lateral and transverse directions. For example, the receiving recesses 210 may be arranged in a rectangular matrix configuration having rows and columns when viewed in a plan view.

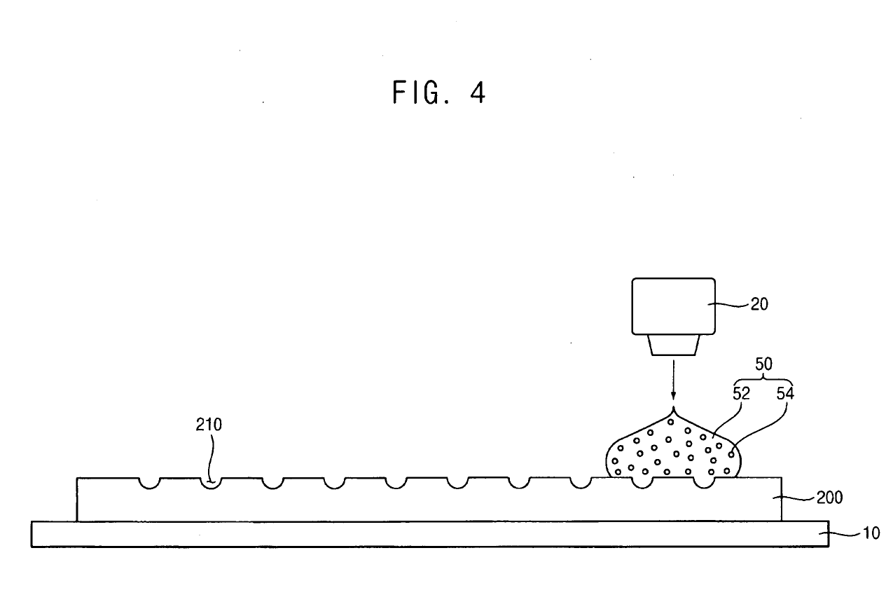

FIG. 4 illustrates a spacer ink 50 being sprayed on the printing plate 200 with a spacer ink sprayer 20. In the exemplary embodiment illustrated, the spacer ink 50 is sprayed on only an end portion of the printing plate 200. The spacer ink 50 includes a liquid ink carrier 52 having a controlled viscosity and a plurality of spacers 54 uniformly dispersed within the liquid ink 52. The ink 52 has a selected, controlled viscosity and thermosetting properties. The ink 52 may be, for example, a white ink. Examples of materials that may be used for the ink 52 include melamine resin, polyester resin, and the like. The rigid spacers 54 are randomly dispersed in the liquid ink 52. For example, the quantity of the spacers 54 may be about 30% to about 40% by weight of the total weight of the spacer ink 50. Each of the spacers 54 may have a spherical shape having a diameter of from about 3 μm to about 5 μm (1 μm=1×10⁻⁶ meters).

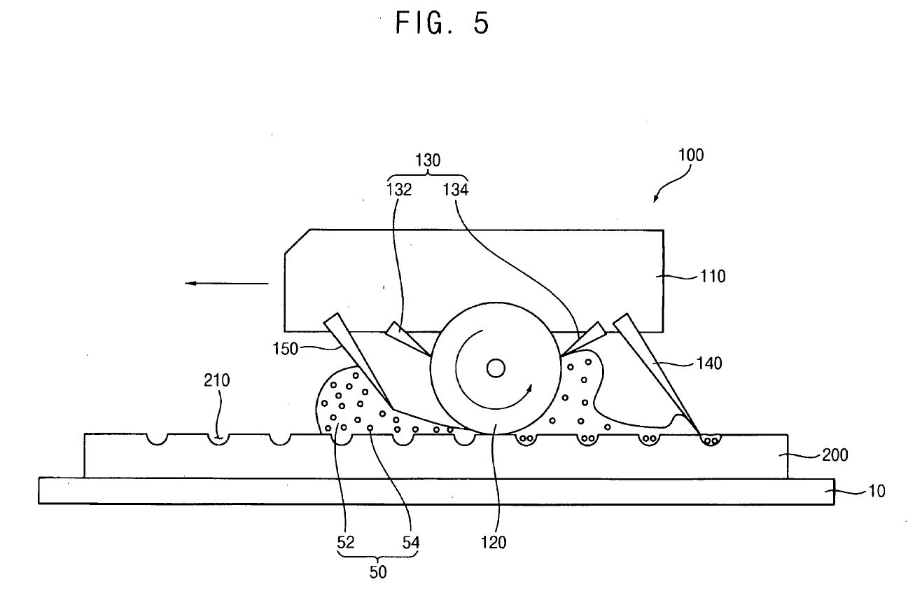

FIG. 5 illustrates the spacer ink printing apparatus 100 being translated in a first direction relative to the printing plate 200 to force the spacer ink 50 in each of the receiving recesses 210 of the printing plate 200. In the exemplary embodiment illustrated, about five to eight of the spacers 54 are forced into each of the receiving recesses 210.

In the exemplary embodiment of FIG. 5, the spacer ink printing apparatus 100, like those described above, includes a main body 110, a pressing roller 120, a spacer ink guiding portion 130, a spacer ink removing portion 140 and a spacer ink spreading portion 150. As may be seen by a comparison of FIGS. 2 and 5, the spacer ink printing apparatus 100 illustrated in the latter figure is substantially the same as that illustrated in the former, and accordingly, further description thereof is omitted for brevity.

As in the embodiment of FIG. 2, the spacer ink spreading portion 150 of the apparatus 100 functions to reduce the height of the volume of spacer ink 50 disposed on the printing plate 200 before it is contacted by the printing roller 120. After it is reduced in height, the spacer ink 50 is guided onto the pressing roller 120 by the first spacer ink guiding portion 132 such that the spacer ink 50 is pressed uniformly into the ink-receiving recesses 210 of the printing plate 200 by the pressing roller 120. Thus, the spacer ink 50 is uniformly disposed in each of the receiving recesses 210 of the printing plate 200. The second spacer ink guiding portion 134 then separates any spacer ink 50 adhering to the backside of the rotating pressing roller 120 from the roller, and the spacer ink removing portion 140 removes any excess spacer ink from the printing plate 200 that was not forced into the recesses 210.

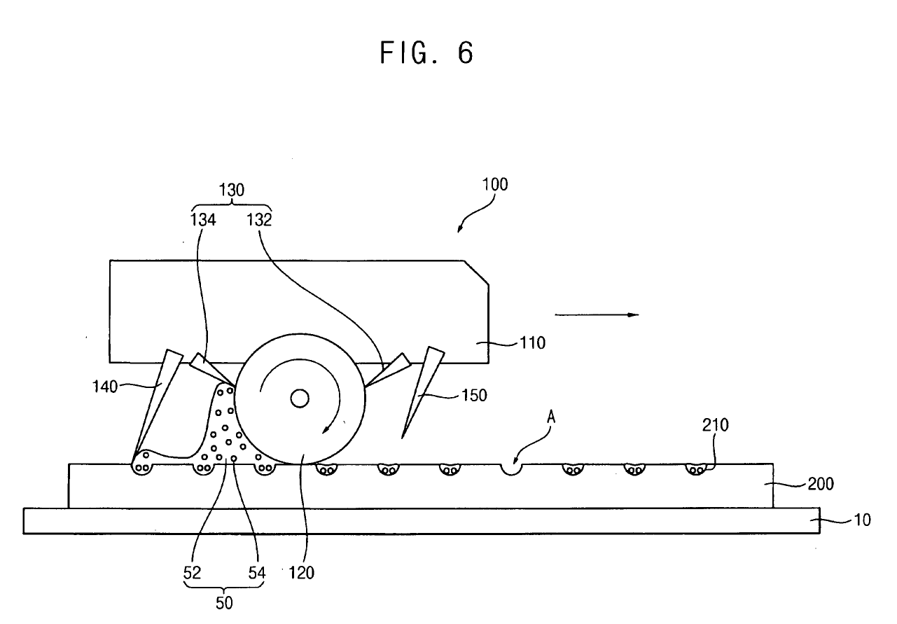

FIG. 6 illustrates the spacer ink printing apparatus 100 being translated in a second direction, as indicated by the arrow of translation, opposite to that in which it is was first translated in FIG. 5, while the pressing roller 120 is simultaneously rotated in a direction opposite to that in which it was rotated in FIG. 5, as indicated by the arrow of rotation therein. That is, by reversing the direction of rotation of the pressing roller 120 as well as the direction of movement of the printing apparatus 100 over the printing plate 200 in the manner illustrated in FIG. 6, the pressing roller 120 can force the spacer ink 50 into any empty receiving recesses A remaining in the printing plate, i.e., any recesses that were missed during the first pass of the roller, as shown in FIG. 5.

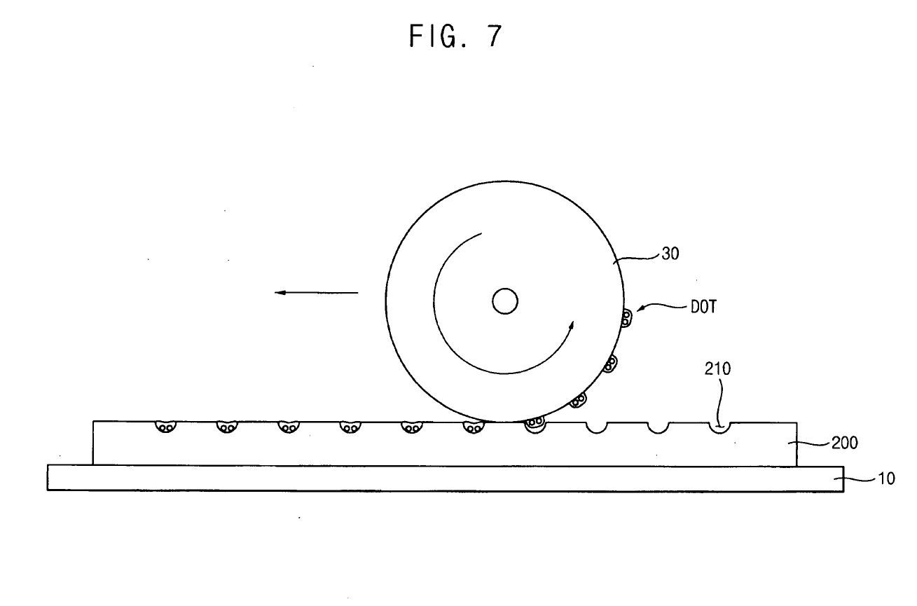

FIG. 7 illustrates a printing roller being rolled over the upper surface of the loaded printing plate 200 to pick up, i.e., to adhere, the respective volumes of spacer ink 50 contained in the individual recesses 210 of the printing plate onto the outer surface of the printing roller. Specifically, the printing roller 30 is rotated while making rolling contact with the upper surface of the printing plate 200 to cause the spacer ink 50 to adhere to the outer surface of the printing roller 30. The individual volumes of spacer inks 50 adhered to the outer surface of the printing roller 30 are spaced apart from each other by the same respective lateral and longitudinal pitches at which they were disposed in the recesses 210 of the printing plate 200 to form a plurality of spacer dots (“DOT”) on the outer surface of the printing roller 30.

Since the liquid portion 52 of the spacer ink 50 has a controlled viscosity, the spacer ink 50 may readily adhere to the outer surface of the printing roller 30. For example, the ink 52 may adhere more readily to the outer surface of the printing roller 30 than to the upper surface of the printing plate 200.

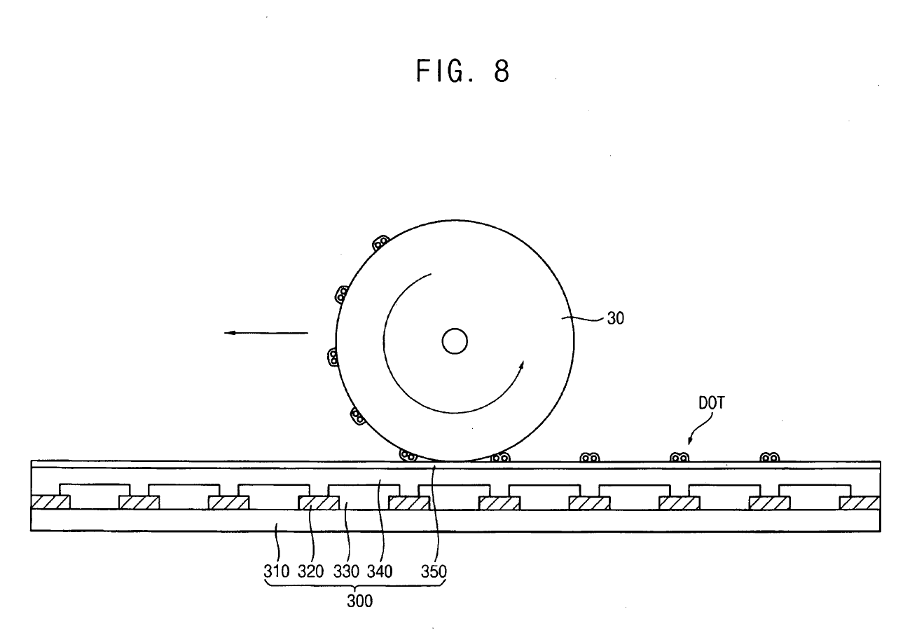

FIG. 8 illustrates the printing roller 30 being rolled over a first substrate 300 to print the volumes, or DOTs, of spacer ink adhering to the outer surface of the printing roller onto the substrate the selected longitudinal and lateral pitches. Specifically, the printing roller 30 is rotated over the first substrate 300 while making rolling contact therewith to adhere the spacer dots DOT adhering to the outer surface of the printing roller 30 onto the first substrate 300 in the respective selected positions thereon. As above, since the liquid portion 52 of the spacer ink 52 has a controllable viscosity, the spacer ink 50 may readily adhere to the first substrate 300, i.e., the ink 52 may adhere more readily to the first substrate 300 than to the printing roller 30.

The first substrate 300 on which the spacer dots DOT are printed may be a color filter substrate, comprising a first transparent substrate 310, a light-blocking layer 320, a color filter 330, a planarizing film 340 and a common electrode 350. The spacer dots DOT may be printed so as to overlie the light-blocking layer 320.

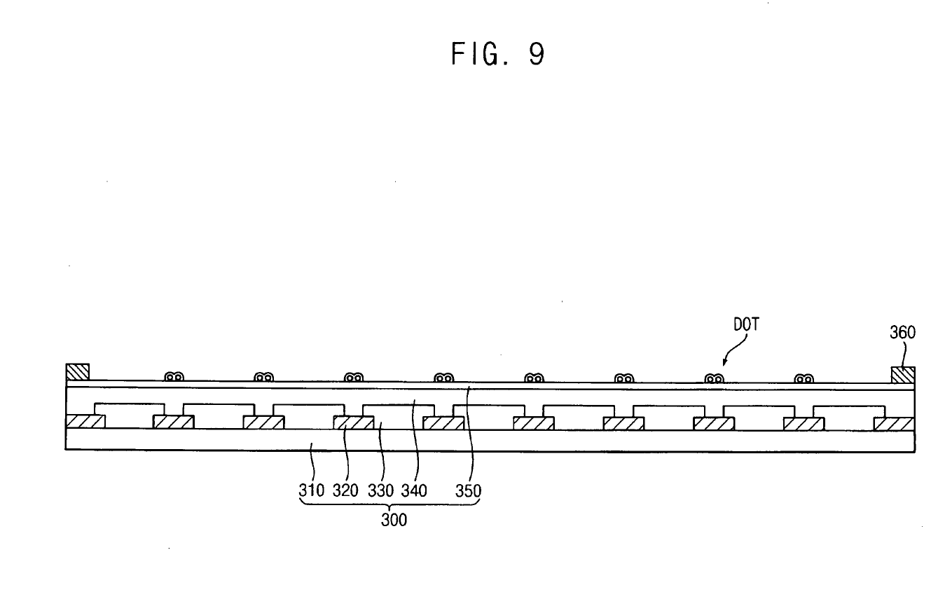

FIG. 9 illustrates a seal line 360 being formed on the first substrate 300 after the spacer dots DOT are printed on it. As shown in FIG. 9, the first substrate 300 may include a display area in which an image is displayed and a peripheral area surrounding the display area. The seal line 360 may be formed in the peripheral area of the substrate and incorporate a closed-loop configuration. The seal line 360 may comprise, for example, a sealant, including a thermosetting material, and a plurality of seal spacers (not illustrated). The seal spacers are dispersed in the sealant and serve to maintain the spacing, or cell gap, between the first substrate 300 and a second substrate 400, as discussed below.

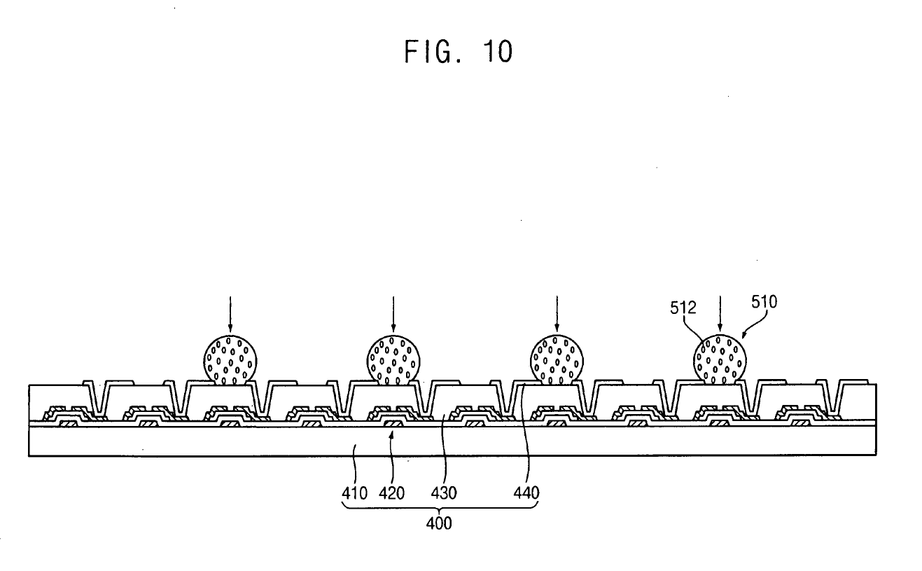

FIG. 10 illustrates a plurality of liquid crystal droplets 510 being dispensed, or dropped, onto a second substrate 400. Each of the liquid crystal droplets 510 comprises a bundle of many liquid crystal molecules that are dispensed onto the second substrate 400. The liquid crystal droplets 510 may be dispensed onto the second substrate 400 simultaneously and independently of the printing of the spacer ink 50 and the formation of the seal line 360 on the first substrate 300. The second substrate 400 upon which the liquid crystal droplets 510 are dispensed may be an array substrate comprising a second transparent substrate 410, a thin-film transistor 420, a protecting layer 430 and a pixel electrode 440.

In the exemplary embodiment of FIGS. 9 and 10, the spacer ink 50 and the seal line 360 are formed on the first substrate 300, as illustrated in FIG. 9, and the liquid crystal droplets 510 are dispensed on the second substrate 400, as illustrated in FIG. 10. Alternatively, however, the spacer ink 50 and the seal line 360 may be formed on the second substrate 400, and the liquid crystal droplets 510 may can be dispensed onto the first substrate 300.

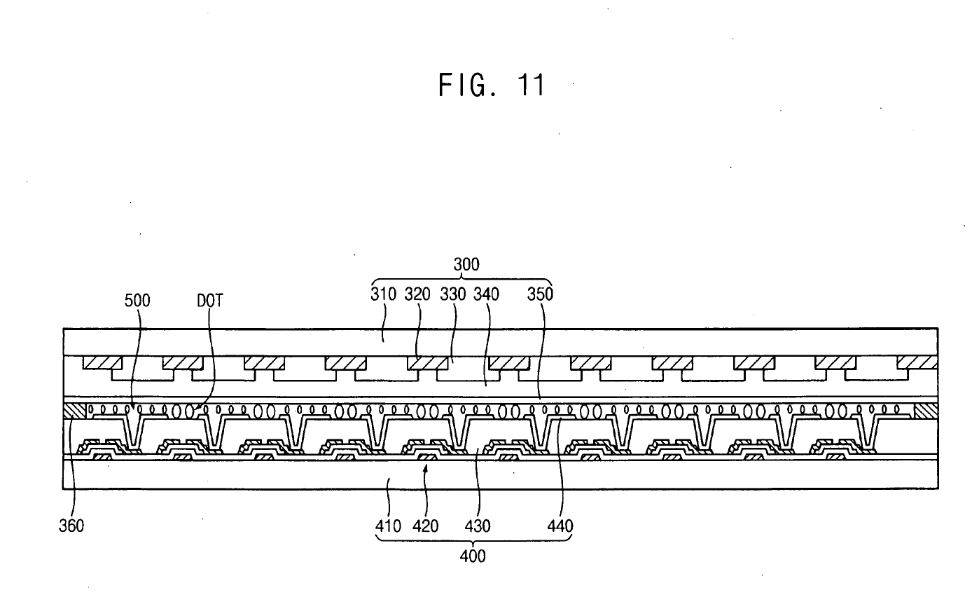

FIG. 11 illustrates the first substrate 300 being combined with the second substrate 400 to seal the layer of liquid crystal material between the two substrates. As shown in FIG. 11, the liquid crystal droplets 510 dispensed onto the second substrate 400 spreads out widely between the first substrate 300 and the second substrate 400 and coalesce to form a continuous layer 500 of the liquid crystal material. The seal line 360 forms a seal between the first substrate 300 and the second substrate 400 and seals the gap between the two substrates so as to prevent the molecules of the liquid crystal layer 500 from flowing out from between the two substrates.

After the two substrates 300 and 400 are combined with each other, as above, the seal line 360 is heated to a selected curing temperature to cure the seal line 360. While the seal line 360 is being cured, the liquid ink 52 of the spacer ink 50 may also be cured simultaneously therewith, such that each of the spacers 54 of the spacer ink are secured in the respective locations at which they were printed on the substrate.

In the exemplary embodiments illustrated herein, the spacer ink spreading portion 150 of the apparatus serves to level, or reduce the height of, the spacer ink 50 previously sprayed onto the printing plate 200 before the simultaneously translating and rotating pressing roller 120 of the apparatus comes into contact with it. The spacer ink guiding portion 130 serves to guide the spacer ink 50 uniformly onto the pressing roller and to remove excess ink adhering to the roller after it presses the ink. Finally, the spacer ink removing portion 140 removes the excess spacer ink 50 that was not forced into the receiving recesses 210 of the printing plate 200, thereby preventing the spacer ink 50 from being wasted and increasing the reuse ratio of the ink.

By now, those of skill in this art will appreciate that many modifications, substitutions and variations can be made in and to the spacer printing methods and apparatus of the present invention and their advantageous use in manufacturing LCD substrates without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A spacer ink printing apparatus, comprising:
a main body;
a pressing roller combined with the main body and arranged to rotate so as to press a spacer ink sprayed onto an upper surface of a printing plate into a plurality of recesses contained therein; and,
a spacer ink removing portion combined with the main body and operable to remove excess spacer ink from the printing plate after the spacer ink has been pressed into the recesses by the pressing roller.

2. The apparatus of claim 1, wherein the spacer ink removing portion is inclined at a selected angle with respect to a line substantially perpendicular to the upper surface of the printing plate such that the pressing roller is disposed farther from a first end portion of the spacer ink removing portion than from an opposite second end portion thereof that is combined with the main body.

3. The apparatus of claim 2, wherein the selected angle of inclination of the spacer ink removing portion is between about 50 degrees to about 80 degrees.

4. The apparatus of claim 1, wherein the spacer ink removing portion is spaced apart from the pressing roller by a selected distance in a direction opposite to a direction in which the pressing roller is translated relative to the printing plate.

5. The apparatus of claim 1, further comprising a spacer ink guiding portion disposed adjacent to an outer surface of the pressing roller and adapted to guide the spacer ink relative to the roller.

6. The apparatus of claim 5, wherein the spacer ink guiding portion comprises:
a first spacer ink guiding portion disposed adjacent to a first side of the pressing roller and adapted to guide the spacer ink uniformly onto the pressing roller; and,
a second spacer ink guiding portion disposed adjacent to an opposite second side of the pressing roller and adapted to separate the spacer ink adhering to the rotating pressing roller from the roller.

7. The apparatus of claim 1, further comprising a spacer ink spreading portion combined with the main body and adapted to reduce the height of the spacer ink sprayed onto the printing plate before it is encountered by the pressing roller.

8. The apparatus of claim 7, wherein the spacer ink spreading portion is inclined at a selected angle with respect to a line substantially perpendicular to the upper surface of the printing plate such that the pressing roller is disposed closer to a first end portion of the spacer ink spreading portion than to an opposite second end portion thereof that is combined with the main body.

9. The apparatus of claim 8, wherein the selected angle of inclination of the spacer ink spreading portion is between about 20 degrees to about 50 degrees.

10. The apparatus of claim 7, wherein the spacer ink spreading portion is spaced apart from the pressing roller by a selected distance in a direction in which the pressing roller is translated relative to the printing plate.

11. A method of manufacturing a display panel, the method comprising:
pressing a spacer ink sprayed onto an upper surface of a printing plate into each of a plurality of receiving recesses in the upper surface of the printing plate by using a spacer ink printing apparatus, wherein the spacer ink printing apparatus comprises:
a main body;
a pressing roller combined with the main body and arranged to both rotate and translate relative to the printing plate so as to press the spacer ink sprayed onto the upper surface of the printing plate uniformly into each of the receiving recesses therein; and,
a spacer ink removing portion combined with the main body and adapted to remove an excessive portion of the spacer ink not pressed into the receiving recesses from the upper surface of the printing plate for reuse in the printing apparatus;
rotating a printing roller over the surface of the printing plate so as to adhere the spacer ink contained in the respective recesses of the printing plate onto an outer surface of the printing roller;
rotating the printing roller over a first substrate so as to print the spacer ink adhered to the outer surface of the printing roller onto the first substrate at selected locations thereon;
forming a seal line around a periphery of the first substrate;
dropping a plurality of droplets of a liquid crystal material onto a second substrate; and,
combining the first substrate with the second substrate such that a layer of the liquid crystal material is sealed in a space therebetween.

12. The method of claim 11, wherein pressing the spacer ink into each of the receiving recesses comprises:
spraying the spacer ink onto an end portion of the printing plate; and,
moving the spacer ink printing apparatus over the printing plate such that the spacer ink is pressed into each of the receiving recesses by the pressing roller.

13. The method of claim 12, wherein moving the spacer ink printing apparatus comprises:
moving the spacer ink printing apparatus over the printing plate in a first direction to press the spacer ink into substantially all of the receiving recesses of the printing plate; and,
moving the spacer ink printing apparatus over the printing plate in a second direction opposite to the first direction to press the spacer ink into any empty receiving recesses.

14. The method of claim 11, wherein the spacer ink printing apparatus further comprises a spacer ink guiding portion disposed adjacent to an outer surface of the pressing roller and arranged to guide the spacer ink relative to the roller.

15. The method of claim 11, wherein the spacer ink printing apparatus further comprises a spacer ink spreading portion combined with the main body and adapted to reduce the height of the spacer ink above the surface of the printing plate before the pressing roller encounters the ink.

16. The method of claim 11, wherein the spacer ink comprises:
a liquid portion having a selected viscosity; and,
a plurality of rigid spacers randomly dispersed within the liquid portion.

17. The method of claim 16, wherein the amount of the spacers is between about 30% to about 40% by weight of the total weight of the spacer ink.

18. The method of claim 16, wherein the ink is thermosetting.

19. The method of claim 16, wherein five to eight of the spacers are received in each of the receiving recesses.

20. The method of claim 16, wherein each of the spacers has a spherical shape having a diameter of from about 3 μm to about 5 μm.
